(19) United States
(12) Patent Application Publication
(10) Pub. No.: US 2024/0094344 A1
(43) Pub. Date: Mar. 21, 2024

(54) MILLIMETER WAVE ADVANCED THREAT DETECTION SYSTEM NETWORK

(71) Applicant: TLC Millimeter Wave Products, Inc., Minneapolis, MN (US)

(72) Inventors: Timothy T. Childs, Minneapolis, MN (US); Daniel C. Eller, Minneapolis, MN (US); Kalyani Mantha, Minneapolis, MN (US); John Geddes, Minneapolis, MN (US); Manish Saka, Minneapolis, MN (US)

(21) Appl. No.: 18/462,113

(22) Filed: Sep. 6, 2023

Related U.S. Application Data
(63) Continuation-in-part of application No. 17/320,001, filed on May 13, 2021, now abandoned.
Application No. 17/320,001 is a continuation of application No. 15/960,245, filed on Apr. 23, 2018, now abandoned.
(60) Provisional application No. 62/488,510, filed on Apr. 21, 2017.

(51) Int. Cl. G01S 7/41; G01S 13/02; G01S 13/04; G01S 13/34; G01S 13/86; G01S 13/88; G08B 13/24

(52) U.S. Cl. CPC G01S 7/417; G01S 7/412; G01S 7/415; G01S 13/0209; G01S 13/04; G01S 13/345; G01S 13/867; G01S 13/886; G08B 13/2491; G08B 13/19695

(57) ABSTRACT

A method of detecting threats. A threat detection system is provided that includes a controller, a millimeter wave radar with transceiver, a signature database, and a camera. The signature database or machine learning includes time and frequency domain characteristic data for a threat. A signal is emitted by the millimeter wave radar. A return signal is received when the signal bounces off an object. Time and frequency domain characteristic data of the return signal is compared to the signature database, or the machine learned characteristics to determine the threat, anomaly, foreign object, material characteristics, and threat speech recognition.

### REFERENCE TO RELATED APPLICATION

This application is a continuation-in-part of U.S. application Ser. No. 17/320,001, filed on May 13, 2021, which is a continuation of U.S. application Ser. No. 15/960,245, filed on Apr. 23, 2018, which claims priority to Provisional Applic. No. 62/488,510, filed on Apr. 21, 2017, the contents of which are incorporated herein by reference.

### FIELD OF THE INVENTION

The invention relates generally to a threat detection system. More particularly, the invention relates to millimeter wave threat detection system.

### BACKGROUND OF THE INVENTION

Terrorist attacks of innocent students in schools, citizen in public places (airports, arenas, religious, dining, and recreational areas, etc.) and community assets such as banks, police, post office, job locations and homes have caused local, national, and international demands for more effective smart security.

There seems is growing number of disgruntled students and citizens seek terror attention and international terrorist groups target to reach US communities, higher level high-tech security systems for the various assets and public gathering areas of our nation and international. However, in addition to these conventional threats, the system also detects and communicates a variety of other threats, examples of which include food, health, crops, animals, mechanical systems, facilities, structure degradation, safety, and verbal threats. To date there is no viable security system that can unobtrusively detect weapons (guns, knives, explosives, chemicals, and verbal threats) prior to the threats' arrival at a target area.

While Wu et al., U.S. Patent Publication No. 2016/0377712, (“Wu”) arguably discloses a radar sensor, image sensor and control unit, the configuration and use of these components is quite different than this invention. Wu describes simply finding the position to map several targets/objects. In contrast, this invention functions to quickly detect and identify threats such that alerts can be sent/streamed that identify the threat type, location, assailant, and/or preprogrammed tasks can be performed to prevent the threat from entering a facility.

The term wave “signature” as used in Wu has a much different meaning than the “signature profile” as is used in this application. Unlike this invention use of greater than 1 million scans per second for threat training, detection and recognition, Wu uses a control unit to capture one reflected wave per object (the object “signature wave”) to label and place the object.

This invention impinges billions of waves/scans onto a target to get the target specific reaction to the transmitted signal. That unique reaction configuration is the threat “Signature Profile” to train the system for distinct identification and detection that also identify the type of threat (gun, chemicals, contraband, etc.) from all other substances and objects, as well as the speed of its approach. The system's voice transmitted with speech recognition, can also instantly identify verbal threats. Wu just wants any difference in reflected wave to map one object relative to another. It is simply for a present object placement among others.

Wu uses the object image to help determine the object direction of moving. In addition to the common name but different meaning and use, the millimeter wave radar with camera utilized in this invention provides the following additional benefits:
A continuous reflected profile of the shape of the target being scanned.
The millimeter wave radar interacts with the molecules of the target to reflect unique characteristics (such as periodicity, configuration, spacing, etc.) which is the molecular characteristic of the target being scanned.
Phase noise of the transmitter signal is extremely low to detect the infinitesimal uniqueness in molecular characteristics, material signature, reflected signal strength versus the distance/location attenuation.

The preceding characteristics cannot be detected using Wu one reflects signal per object particularly where the target object is scanned at a rate of greater than about one million emitting and receiving scans per second as is done with the claimed invention. The millimeter wave scanning at the preceding rate provides the following benefits that are not and cannot be provided by the Wu.

The extremely high scan rate used in this invention enables seeing more structural details of the target that cannot be obtained with the Wu method and system. Additionally, the extremely high scanning rate of this invention provides a greatly enhanced accuracy rate as compared to the scanning process of Wu. For example, matching 999,999 of 1,000,000 scans provides a 99.9999 percent probability of the threat being accurately identified. Furthermore, the results of the millimeter wave threat detection of this invention is not concerned with the activity pattern of non-threat targets as is the case with the Wu objects.

Based upon the preceding comments about Wu, this invention is novel when viewed in light of Wu. Additionally, this invention involves an inventive step because Wu does not teach or suggest the use of machine learning and/or artificial intelligence.

While Levitan et al., U.S. Patent Publication No. 2009/0058710, (“Levitan”) and this invention both utilize scanning with millimeter waves to find threats, there are fundamental differences between the method disclosed in Levitan and this invention.

Levitan describes the use of multi-channel and different polarization schemes for detection. The Levitan method uses two different radars (FMCW and Pulse Doppler) with two different channels and 3 polarization each radar signals at different frequencies to establish a frequency difference and a corresponding harmonic signal.

Levitan is based upon a complex sequence of changes to 2 separate signal values/characteristics that result in a series of unique signals by which the target sequences of polarized signals different wave forms configuration and contrast are used to identify the object.

As Levitan changes the signal characteristics (such as power, collimated size, and polarization) in sweeps of 50 MHz and the corresponding profile results versus signal characteristic changes and sweep. Levitan uses the difference caused to these harmonics by the object to identify the target.

Levitan does not include any details on the speed of the channel processing used nor how to increase the processing speed. However, with the waveform changes, the transmit versus receive polarization characteristics and processing the various series of data for the various transmitted dual signal and polarizations combinations, the data signal process has to take significant time. Based upon the current state of the art processors, there is no processor that can process all of this data at a rate of greater than 1 million scans per second as is done with this invention.

In contrast, this invention utilizes a simple approach that enables ultra-high-speed scanning at a rate of greater than 1 million scans per second with an extremely clean low noise signal that make possible the instant detection and identification of targets through unique infinitesimal changes uniquely generated by the target into the reflected signal that are compared to the machine learned signature database, that can match and thereby identify that target.

This invention is not dependent on mixing polarization to detect the threat. Instead, this invention can identify the molecular signature into the radar reflected signal that provides the target composition, shape, and location of the target from the change in the transmitted signal. Because of these differences, this invention is quite different than the method of Levitan.

### SUMMARY OF THE INVENTION

The purpose of this technology is to utilize a radar system to automatically detect threats and or other items autonomously in advance, while communicating in real-time to authorized local, national or authorities the threat foreign object anomaly types, location and rate of travel towards a target or important asset.

This system does not need any human involvement to operate and, as such, is operably at all times. The invention reduces the risk of human error in the critical path of detection threat. The purpose is a remote durable system that virtually eliminates terrorist threats to innocent communities.

An embodiment of the invention is directed to a method of detecting threats. A threat detection system is provided that includes a controller, a millimeter wave radar, a signature database and a camera. The signature database includes time and frequency domain characteristic data for a threat. A signal is emitted by the millimeter wave radar. A return signal is received when the signal bounces off an object. Time and frequency domain characteristic data of the return signal is compared to the signature database.

Another embodiment of the invention is directed to a threat detection system that includes a controller, a millimeter wave radar, a signature database, and a camera. The millimeter wave radar is capable of emitting a signal and receiving a return signal that bounces off an object. The signature database contains time and frequency domain characteristic data for at least one threat. The controller compares the return signal to the time and frequency characteristic data to identify a threat. The radar provides the referenced location (X, Y, Z), position, and image size for the controller to direct the camera to the threat and captures/stream images of the threat, which then uses those auto streamed pictures or live videos to authorize the person or IP address

Another embodiment of the invention is directed to a threat detection system that includes a controller, a millimeter wave radar, a signature database, and an access control device. The millimeter wave radar is capable of emitting a signal and receiving a return signal that bounces off an object. The signature database contains time and frequency domain characteristic data for at least one threat. The controller compares the return signal to the time and frequency characteristic data to identify a threat. The access control device is associated with the structure. The access control device engages when the threat is detected.

Embodiments of this invention are directed to autonomous methods for rapid threat detection and identification. Such a process enables authorities to be rapidly notified while continually monitoring and preventing a listed of threats from activation and from accessing facilities of interest. In addition to activating an alarm, the system can automatically engage building locks when a threat is detected proximate the building.

The autonomous rapid threat detection system is provided that includes an ultra-fast controller, a millimeter wave radar with machine learning and artificial intelligence, a smart rotating PTZ camera that also includes machine learning and artificial intelligence, a data base and high-speed computer with a high-speed modem such as communicating at a rate of greater than about 1 gigabit per second.

The system includes a field programmable gate array (“FPGA”) that is capable of processing 65 million samples per second. Once triggered, the FPGA continuously generates and manages streams of 100 Hertz triangle waves on the transmitting FMCW radar millimeter wave signal scanning for threats at a rate of greater than 1 million scans per second.

The FPGA then transfers from the streaming reflected millimeter wave signal, the target signature profile to the artificial intelligence signal processing to identify or confirm for the camera (or vice versa) any threat signatures. This complete detection process is autonomously performed within seconds of the threat transversing the radar or camera (both with ML/AJ) peripheral in the vicinity where the threat detection system is located.

After initial deployment, with the required threat detection accuracy of greater than 95 percent, this ultra-high-speed dual artificial intelligence millimeter wave radar/camera rapid threat detection system continually self-trains and learns in the installed environment. In certain embodiments, the threat detection system needs no human involvement until the system auto notifies maintenance, authorized personnel, or its network operation center (“NOC”) that the threat detection system needs adjustments.

Important hardware components of the threat detection system include a high-speed computer that is capable of rapid data transfer rates. In certain embodiments, the data transfer rates are greater than about 10 gigabits per second. A computer having the preceding characteristics is capable of obtaining highly reliable results.

Another hardware component for the threat detection system is the FPGA that includes more than 500,000 logic elements that are uniquely programmed such as using hardware description language (“HDL”) of Verilog and very-high density language (“VHDL”) to generate 100 Hertz waves and manage the millimeter wave signal at up to about 65 million scans per second. Illustrated in regions b and c of FIG. 2.

Another hardware component of the threat detection system is an ADC/DAC daughter card that creates a balance between excellent signal resolution and high sampling rate such as greater than about one million per second. Illustrated in region a.i of FIG. 2.

Another hardware component of the threat detection system is a frequency-modulated continuous wave millimeter (“FMCW”) wave radar. Illustrated in region a.iii of FIG. 2. The radar may include monolithic microwave integrated circuit (“MMIC”) oscillators 4,6,7, quadrature phase shift keying (“QPSK”) or phase angle modulators MMIC-5 or multi-purpose millimeter wave MMIC radar transceiver communication chip 3. The transceiver chip uses speech recognition with ML/AI of threat words and phrases to identify verbal threats that may proceed or accompany a weapon or physical threat. The radar module should have a phase noise of less than or equal to 90 dB at 100 kilohertz offset, a transmit power of greater than or equal to 12 dBm, a receiver gain of greater than or equal to 50 dB, a frequency typically between 246 Hz to 500 tetra hertz or more with greater than or equal to 2 gigahertz band width, a noise figure (signal to noise ratio) of greater than or equal to 35 dB and an IF noise floor of less than or equal to −120 dBm/Hz.

Another hardware component of the threat detection system is a range taper or bandpass filter that controls the optimum range/distance of detection Illustrated in region c of FIG. 2.

Another hardware component of the threat detection system is a camera. An example of a suitable camera is a smart PTZ camera with a machine learning processing unit with AI algorithm for instant detection identification. The camera should have a shutter speed of greater than or equal to 10-3 seconds. The camera should also have autofocus capability with zoom of greater than or equal to 30 times. The camera should be able to record HDTV at 1080p or higher resolution. Illustrated in region b of FIG. 1.

The hardware component of the threat detection system should have a high-speed modem that is capable of transmitting at a rate of greater than or equal to 10 gigabits per second that is capable of streaming information, voice, data and video when a threat is detected. The high-speed modem may be integrated in the computer.

Using computer software or hardware programming in a variety of languages such as Python, C++, Java and Matlab that is integrated within at least one of the preceding hardware components of the threat detection system. When the system scans across a target or a target traverses across the scanning region, there are at least the following methods of rapid threat detection, confirmation and notification.

Millimeter wave radar imaging of concealed or exposed threats includes a power of greater than 10 dBm at less than 400 feet, thin materials such as backpacks, clothing and paper bags can be penetrated using millimeter waves having a wavelength of about 10-3 meters. Accordingly, millimeter wave FMCW radar with machine learning and artificial intelligence detected threats can be imaged via a reflected signal revealing the detected threat shape and color coded based on the comparative amplitude of the reflected signal. The results of this process are color images of the targets for the camera to do threat confirmation of the concealed weapon. FIG. 8 indicates that the results of a series of one second scans of a moving backpack with and without a gun at a scanning rate of about 200,000 scans per second. FIG. 9 indicates the results of the scans on stationary empty plastic bags, plastic bags with oak seeds and plastic bags with barley seeds.

The millimeter radar spectroscopy by which small 10⁻³ wavelength interact with the propeller of UAV/Drone or similar to capture into the database the spectra signature profile vs type of UAV system to use the ML/AI learned radar system to detect roque UAV/Drone from those authorized to occupy a given space. FIG. 9b indicates the profile results of scans from a friendly UAV.

Scanning at a rate of greater than or equal to 1 million scans per second data points significantly increases the resolution of the image for identification with the camera using machine learning and artificial intelligence.

The millimeter wave radar spectroscopy by which the small 10-3 wavelength interacts with the molecular structure of the target and reflects the unique molecular signature of the target. FIGS. 10a-10c and 11a-11c. The greater than or equal to 1 million scans per second increases the detail to uniquely define the consistent pattern or signature of the recognition.

Artificial intelligence recognition is performed by scanning known threats for minutes in all directions at a rate of greater than or equal to 1 million scans per second. Thereafter, the trained system can instantly detect the trained threats in the field. Greater than 1 million scanning profiles contain the raw three-dimensional data of over a billion data points that make up the intricate detailed profile of the threat in the time and frequency domain. For example, training for about 60 minutes generates greater than about 3.6 billion data points. This result is similar for the computer vision machine learning and artificial intelligence training. Accordingly, the system knows with high precision (greater than 95 percent accuracy) (greater than 950,000 matches per 1,000,000 scans) what a threat looks like FIG. 14.

Another aspect of the invention relates to the use of camera vision recognition of open and enclosed threats. The camera vision system attempts to capture all of the specific types and general categorial distinguishing feature details of the threat for the vision system database. Such can be obtained from a variety of internet photos and images. The camera vision system utilizes machine learning and artificial intelligence to detect, recognize, and lock-on to individual threats or multiple threats. The vision system provides an accuracy of greater than 95 percent illustrated in FIG. 15.

Using the radar produces greater than 4-billion-pixel precise images of concealed threats. The camera is also trained on the radar-produced images of concealed threats. Using these two types of camera machine learned vision recognition methods enables capturing over 100,000 images per second. The camera recognition system can recognize a threat in well less than a second with an accuracy of more than 95 percent. Stated another way, there are greater than 95,000 matches per 100,000 pictures per second.

An important aspect of the invention is avoiding false positives. In this regard, the invention utilizes a dual system cross check verification. If the camera detects a threat, the camera automatically notifies the radar to scan the suspect target to confirm the threat. Using detection methods described above with detection accuracy of greater than 95 percent, the radar confirmation thereby increases the threat detection accuracy and helps avoid false positives.

If the radar detects a threat, the radar notifies the camera to scan and confirm the threat. The dual system can do all of the above in the time domain methods or also in frequency domain mode. In all cases, each time a threat detection is verified, an autonomous alert is sent.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a high-level system configuration of an autonomous threat detection security system according to an embodiment of the invention.

FIG. 2 is a low-level sample configuration of Section a in FIG. 1.

FIG. 3 is a block diagram of radar stationary object.

FIG. 4 is a top-level block diagram of an altera device.

FIG. 5 is a graph of output from a digital to analog converter module.

FIG. 6 is a snapshot of Ethernet packet output.

FIG. 7 is a chart of detected packet data.

FIG. 8 is a series of scans of a backpack containing different objects therein.

FIG. 9 is a series of scans of an empty plastic bag, a bag containing barley, a bag containing oats and a bag containing a mixture of barley and oats.

FIGS. 10a, 10b and 10c is a series of time domain scans of an empty plastic bag, a plastic bag with barley and a plastic bag with oats.

FIGS. 11a, 11b and 11c is a series of frequency domain scans of an empty plastic bag and a plastic bag with oats.

FIG. 12 are frequency graphs for several objects.

FIG. 13 are time domain graphs for several objects.

FIG. 14 is a result of scans for gun detection, oil detection and Tannerite detection.

FIG. 15 are photos showing the threat detection system locking on to different threats.

FIG. 16 is an illustration of the invention creating a representation of a detected object.

FIG. 17 is a block diagram of a database for use in conjunction with an embodiment of the threat detection system.

FIG. 18 is a flow diagram of a frequency-modulated continuous wave radar system detecting a reflected signal from an object.

FIG. 19 is a graph of the frequency-modulated continuous wave radar with transmitted and reflected frequency versus time.

FIG. 20 is a graph of the frequency-modulated continuous wave radar with a Doppler shift transmitted and reflected frequency versus time.

FIG. 21 is an illustration of the threat detection system implemented at a school.

FIG. 22 is a perspective view of an FMCW radar detector.

FIG. 23 is a baseline ambient profile received by the FMCW radar detector.

FIG. 24 is a profile received by the FMCW radar detector when the drone's propeller is spinning.

### DETAILED DESCRIPTION OF THE INVENTION

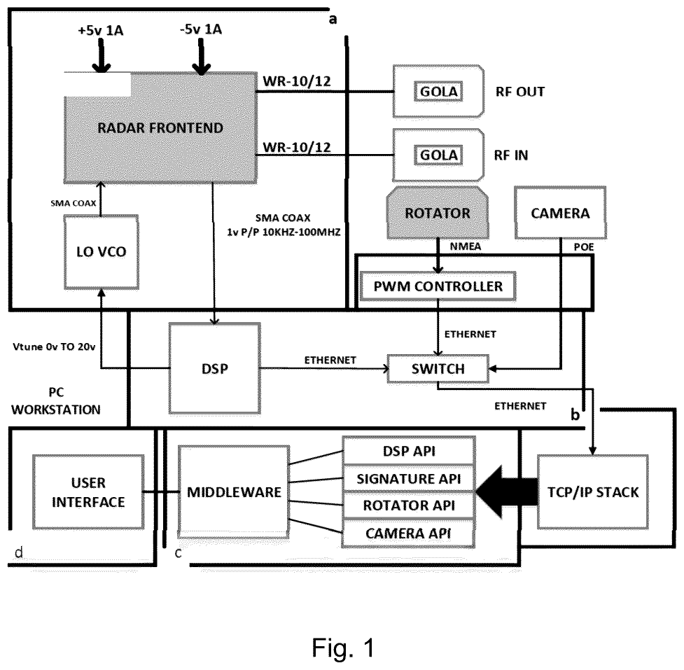

An embodiment of the invention is directed to an autonomous threat detection radar security system network with advanced threat detection, direct control to security camera, ultra-fast communication authorities that can also automatically deny entry to the suspect without the suspect knowing they were scanned. FIG. 1 gives the high level system configuration of the autonomous threat detection radar security system network according to an embodiment of the invention.

Key features include integrating four innovative technologies areas to develop and implement a millimeter wave security system network that detect and communicate the threat in advance.

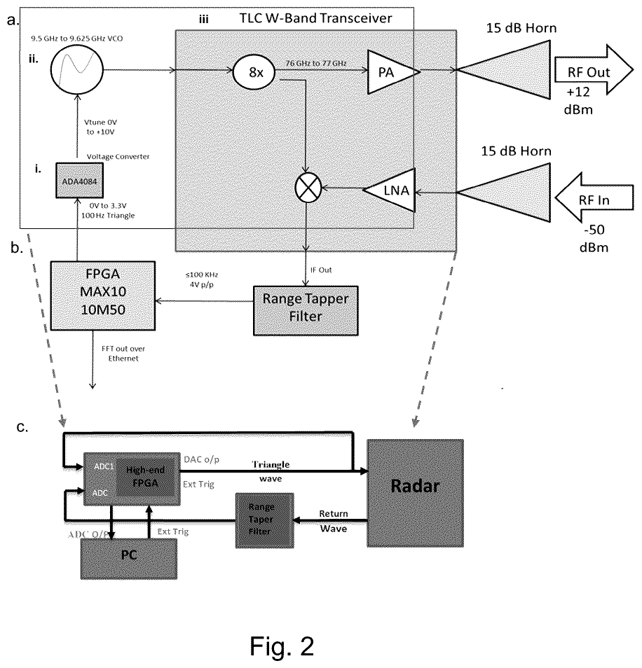

FIG. 2 is the low level sample configuration with section “a” in FIG. 1, indicating the millimeter wave front end with variations of design and integration of patented millimeter wave radar and communications technology including low phase noise signal source (U.S. Pat. No. 6,384,691) and/or monolithic integrated transceiver (U.S. Pat. No. 8,467,739) and/or phase angle modulator (U.S. Pat. No. 6,060,962) and/or monolithic integrated voltage controlled coupled feedback oscillator (U.S. Pat. No. 7,068,115), the contents of which are all incorporated herein by reference.

These devices all are tested and proven to provide high frequencies from 10 to 110 GHz (to 300+ GHz with multipliers) to transmit and receive signals for scanning and detection threats, foreign objective, material resistivity, contaminants, DNA, anomalies intruders, using various size and configuration radars and transceivers, monolithic microwave integrated circuit and modules as the radio frequency front end of the system with high resolution to detect material, liquid or gas composition, shape, location and velocity that can continually scan an area, food, facility, conceal enclosures, vehicle, vessel, pipe, ground, animal or human fluids or similar over 1 million scan per second.

Ultra-high speed signal processing such as greater than about 10 Gbps can also be used such as illustrated in Section b of FIG. 1. That technique is developed and integrated into ultra-high speed data processing that can process continual streaming of real time data inputs with no delays when integrated to millimeter wave transmit and received versus and audio to digital converter.

Signature database and matching software can also be used such as illustrated in Section c of FIG. 1. This aspect develops and integrates with the millimeter wave radar and ultra-high speed signal processing sonic algorithm programming that match threat signal to their unique signature profile in the system database. Similar to finger printing, eye recognition or internet search matching to a known profile in the database.

Ultra-high speed millimeter wave communication network can also be used such as illustrated in Section d of FIG. 1. This aspect includes using millimeter wave components and transceivers system as transceiver (U.S. Pat. No. 8,467,739) and/or phase angle modulator (U.S. Pat. No. 6,060,962) and/or monolithic integrated voltage controlled coupled feedback oscillator (U.S. Pat. No. 7,068,115).

These systems include fiber optic converter, fiber optics, satellite modems, high speed router and/or repeaters to communicate from various front scanners to the signal processing as well the resulting signal processing and data match information indicators to the phones, computers, tablets via millimeter wave frequency directly or downloaded to wireless networks or fiber network or via to satellite the system resulting voice, data, video at high speed greater up to and beyond 50 Gbps speed to authorized personnel and centers.

These four preceding technologies are integrated into a reliable durable system feeding into a millimeter wave mixed media communications network for millimeter wave detection systems system.

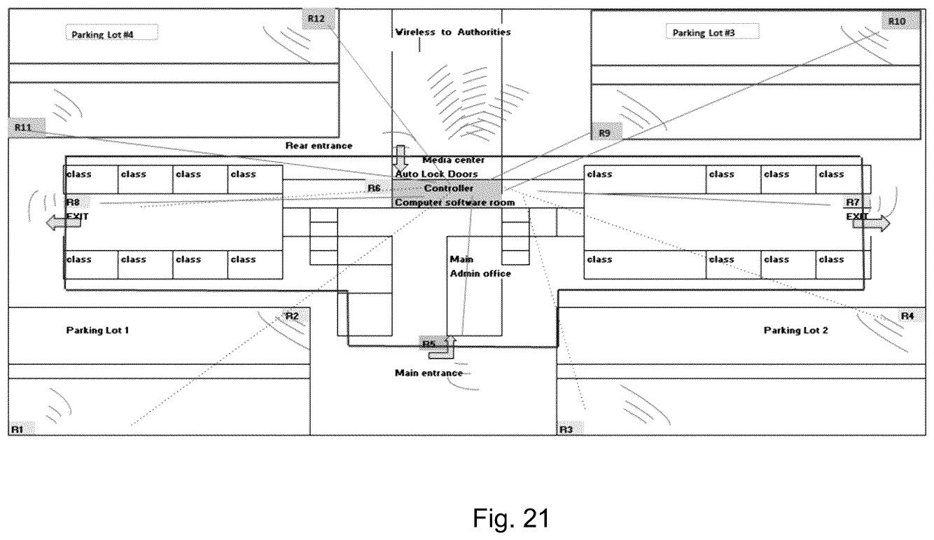

This proven millimeter wave capability is to be combined with advanced signal processing and threat signature recognition to be outlined in the design and implementation section. The system can continually scan throughout the school for internal and external threats. FIG. 21 illustrates the threat detection implemented in conjunction with a school. The system can lock doors of the school to deny suspect entrance when a threat is detected proximate to the school. The system also includes a control camera to continual stream video to public safety of location and activities in real time.

Examples of public safety include police, security, and military. An important aspect of the invention is for the scanning and detection to be done without the suspect being aware of the detection. This process enhances the ability of the public safety to neutralize the threat for police to scan vehicles that they pull over before approaching the vehicle. The invention thereby enables persons to be evaluated for possessing threats in a non-individualized manner by which each person, facility and vehicle is separately scanned before entering an area.

The invention has multiple modes of operation. For detection, identification, tracking, monitoring, and locating, the scan rate may be greater than about 1 million scans/sec. For communication (voice, data, and video) at data rates, the scan rate may be greater than about 50 Gb/sec.

The radar used in conjunction with the invention can range over a wide range of sizes from micro single chip dual radar transceiver having a size of less than 3 millimeters by 9 millimeters to larger 360-degree rotating domes radars.

Utilizing millimeter wave radars having a large variety of sizes allows coverage of nearly any distance range utilizing a range of millimeter wave frequency desired. The coverage can range from less than one meter to more than one kilometer. When the miniature millimeter wave repeaters are utilized, a detection and communication network can cover an entire city while the presence of which may be difficult to see.

Using the capabilities outlined above, the invention can provide early threat identification and communication. Once a threat is identified, the system communicates to the camera to perform a detailed re-investigation of the threat to reconfirm findings as well as search for other indicators such as trigger, a bullet magazine, a pull pin, fuse, a lighter, a wick, a scope, keypad, etc. The image of the suspect can also be used to obtain personal information on the suspect.

Once the threat has been re-verified, the system can implement lock down of the impacted area and then transfer the information to the appropriate authorities. The millimeter wave threat detection system network can be set up in a variety of configurations. For example, long range radars (larger radar-node) can be placed in a high inconspicuous position (i.e., roof, towers, etc.). Smaller or microscopic units can be above the entry doors and micro units along the path ways in the lights, etc.

The system network may include overlapping coverage of all angles for a match to the threat signatures, as the public moves in a normal manner unaware of the monitoring. All nodes are connected to the security network processing center with trigger to connect to local authorities (police) and/or national authorities (Department of Homeland Security and FBI). The system can also provide notification to persons associated with the area being monitored such as building management and security.

This threat identification and location information can also be accompanied with other information such as a picture of suspects, eye/facial recognition results, license plates, and other descriptors in the automatically notification to authorities. This notification is done in a relatively short period of time such as less than about one minute. In other embodiments, the notification is done in less than about 10 seconds. Such rapid notification may be done without the suspect being aware of the detection.

FIG. 2 is the low-level configuration that is to interface with an ultra-high speed signal process system. FIG. 2 is configured such as for school radar that can scan up to 0.5 miles away. However, the software development with signal process and database management development must be compatible to continually intake the radar signal at greater than about 1 million scan packet per second.

The field-programmable gate array has been an integral part of the invention due to its ability to enable higher integration, higher performance, and increased flexibility to implement any mathematical function.

The field-programmable gate array is introduced in the low-level configuration because the speed of data processing must be very high to handle huge, sampled data stream at higher clock frequency. Many dedicated functions and internet protocol (“IP”) core are available for direct implementation in a highly optimized form within the field-programmable gate array.

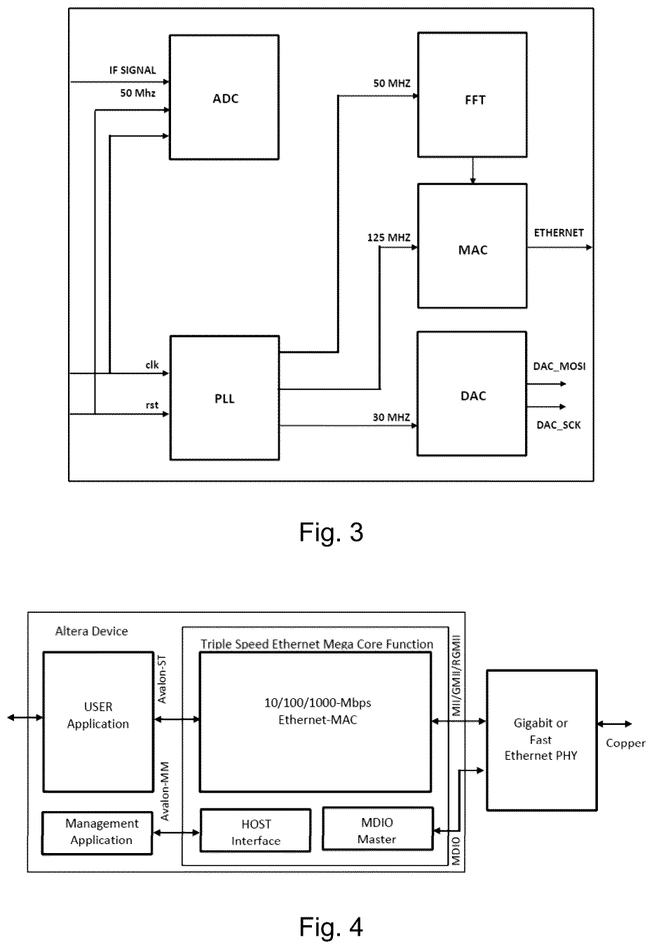

A top-level block diagram of detection of a stationary object from radar is set forth in FIG. 3. The input to the design is intermediate frequency (“IF”) signal from the range tapper filter which is less than or equal to 100 KHz, 4V p-p. This analog signal is received by analog-to-digital converter module to convert the analog input form to digital form, and then the fast Fourier transform is applied on that obtained digital data to get the frequency information of the input data, i.e., to find out the stationary object information. The result of this process is sent out such as using an Ethernet cable. A triangular waveform is generated by digital to analog converter module of 10 milliseconds. A person with skill in the art will appreciate that it is possible to use other mechanisms to transmit the data such as wireless.

The fast Fourier transform (“FFT”) is performed on the digital data available after the random-access memory (“RAM”) memory. The fast Fourier transform output gives the frequency information of the data.

The analog-to-digital converter (“ADC”) module is instantiated using an IP core. The analog-to-digital converter solution consists of Hard IP blocks in the Max10 and soft logic through an Altera modular analog-to-digital converter IP core. It translates the analog quantity into to digital data.

Ethernet media access control (“MAC”) Core: Altera Triple speed Ethernet consists of a 10/100/1000 Mbps Ethernet MAC IP. This IP function enables Altera field-programmable gate array to interface to an external physical layer transceiver (“PHY”) device which, in turn, interfaces to the Ethernet network. Max 10 field-programmable gate array board uses a RGMII interface.

Control of 16 bit digital to analog converter (“DAC”) module (DAC8551) through serial peripheral interface (“SPI”) on Altera MAX10 Starter Kit (24 bit mode), output voltage 0.25 V @ 2.5 V reference voltage. Can be up to 5 V with another reference voltage.

It is a frequency control system that generates an output clock by synchronizing itself to an input clock. The phase lock loop (“PLL”) module compares the phase difference between the input signal and the output signal of a voltage-controlled oscillator module.

The triple speed Ethernet IP Core, which is illustrated in FIG. 4, compiles with IEEE 802.3 standard. The analog-to-digital converter details used here are mentioned above. Table 1 includes the parameters taken in the analog-to-digital converter setting. The analog-to-digital converter computation takes approximately 50 clicks to generate every output. The analog-to-digital converter output samples are obtained for every 1 MHz click (1 μs), which transmits 1 million samples per second.

TABLE 1

| No. | Parameter | Value | |
|---|---|---|---|
| 1 | Input frequency | <100 | KHz |
| 2 | ADC frequency | 2 | MHz |
| 3 | ADC Used | Single ended unipolar straight binary code | |
| | | scheme, which contains all unsigned values. | |
| 4 | Output no. of bits | 12 | bits |
| 5 | Output codes | 2\hat{ }n = 4096 | |
| 6 | No. of steps | 4095 | |
| 7 | Resolution | 1/4095 = 2.44 × 10E−4 | |
| 8 | Step size | Vref/2\hat{ }n = 2.5/4096 = 610.35 μv | |
| 9 | Vin | o/p/2\hat{ }n *Vref | |
| 10 | Ref voltage | 2.5 v (internal ref voltage used) | |
| 11 | Sample frequency | 1 | KHz |
| 12 | Channel used | CH0, dedicated analog pin | |
| 13 | ADC used | ADC-1st | |
| 14 | Core variant | Standard sequencer with external sample storage | |
| 15 | No. of slots used | 1 | |
| 16 | Sampling Frequency | 1 | Million samples/sec |

To control analog-to-digital converter and to take the analog-to-digital converter data, there is a component added, which has a master and a slave. It has an Avalon master to control analog-to-digital converter and it has a section which has Avalon streaming sink to receive the analog-to-digital converter data.

The Altera function IP core may be used to convert the unsigned numbers to single precision floating-point 32-bit values. The latency of this IP core is 8 clicks. The output from this module is given as an input to the dual port random access memory (“DPRAM”).

The DPRAM may use altera IP core. This RAM is used because the input to the fast Fourier transform should be in a continuous form, but the output of the analog-to-digital converter comes in a single clock basis (which is not continuous). The DPRAM is used so that the writing is done slowly but reading is done simultaneously and given as input to the fast Fourier transform module. The input may be in single precision floating point value.

The fast Fourier transform is set forth in Table 2.

TABLE 2

| S No | Parameter | Value |
|---|---|---|
| 1 | Length | 256 |
| 2 | Direction | Forward |
| 3 | Data flow | Variable streaming |
| 4 | Input order | Natural |
| 5 | Output Order | Natural |
| 6 | Data | Single floating point |
| | representation | (input width is default 32 bit) |

There are options used in the MAC Core configurations such as 10/100/1000 Ethernet Mac; reduced gigabit media independent interface (“RGMII”); and use of internal first in, first out (“FIFO”). MAC options include enable 10/100 half duplex support; statistics counter. FIFO options include width: 32 bits; depth: transmit—1024×32 bits and receive—64×32 bits.

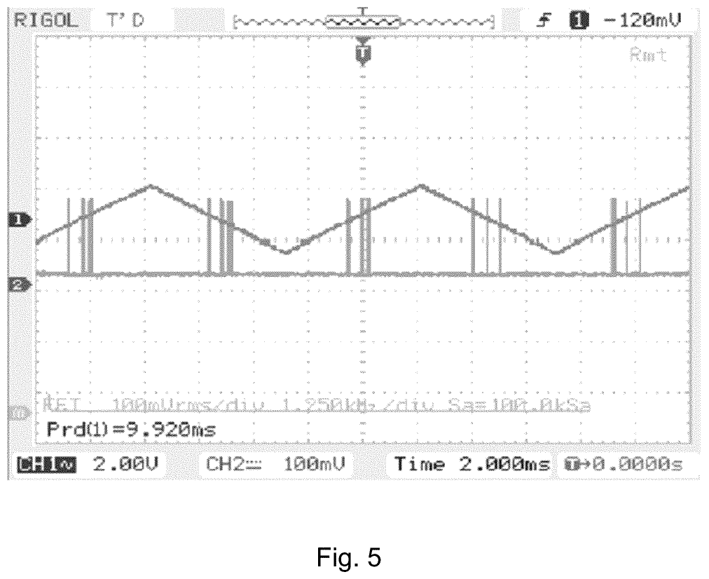

Control of 16 bit digital to analog converter module (DAC8551) may be through serial peripheral interface (“SPI”) on Altera MAX10 Starter Kit (24-bit mode), output voltage 0.25 V @ 2.5 V reference voltage but can be up to 5V with another reference voltage. Output of the digital to analog converter module is set forth in FIG. 5.

Calculation to generate the triangular waveform include output voltage=(PATTERN/65536)*Vref=(PATTERN/65536)*2.5V. Max output: 2.5V.

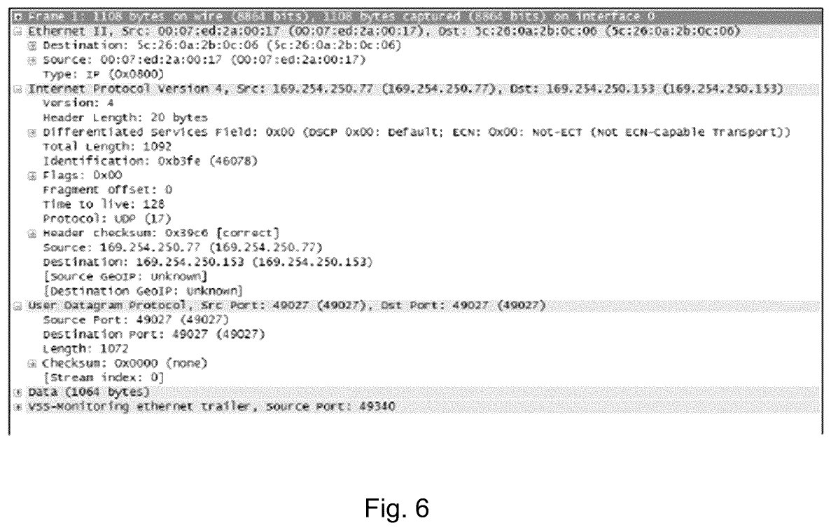

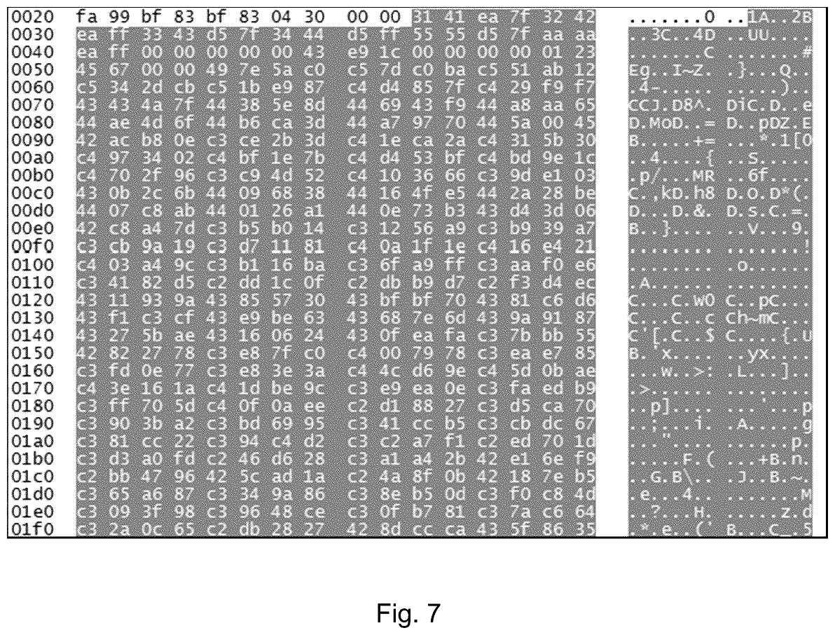

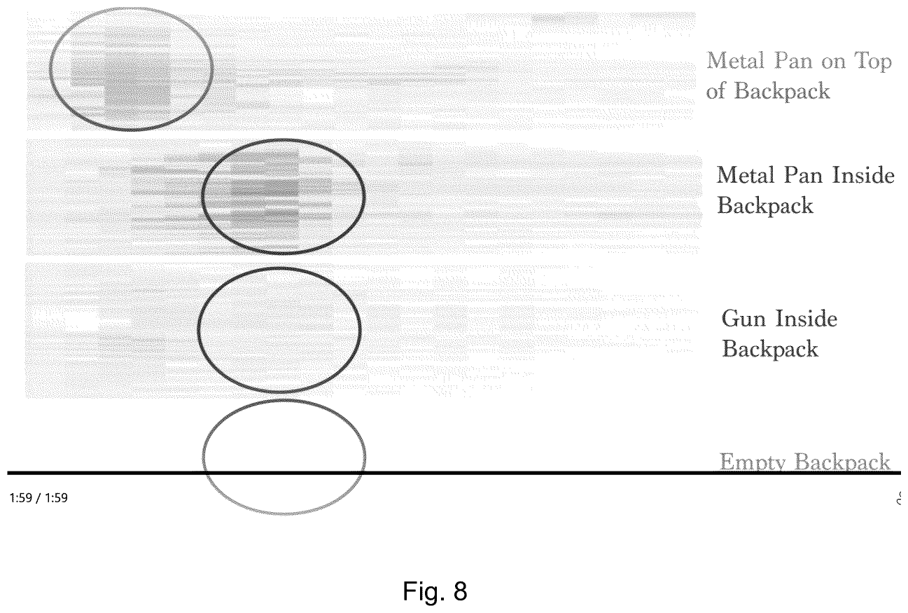

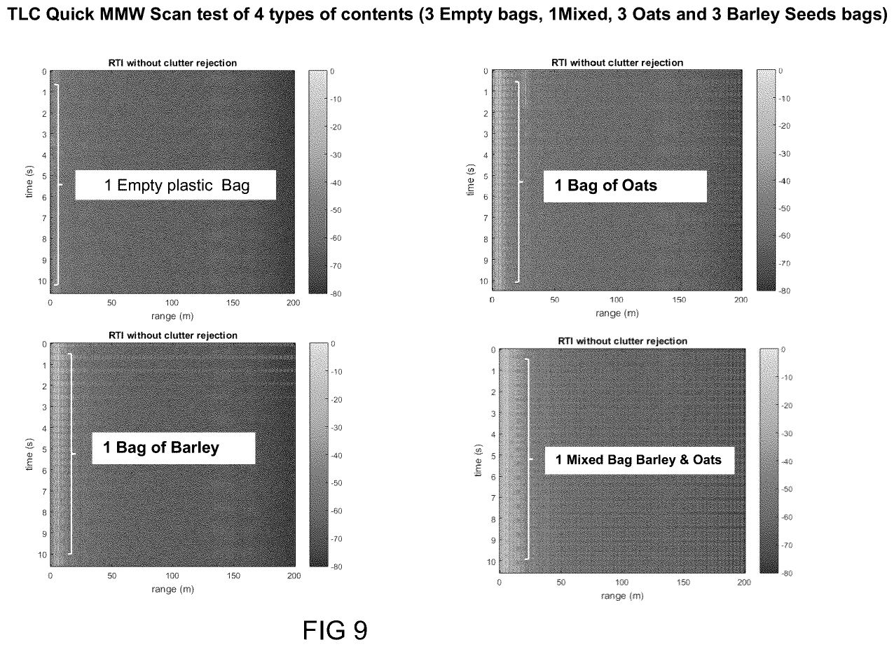

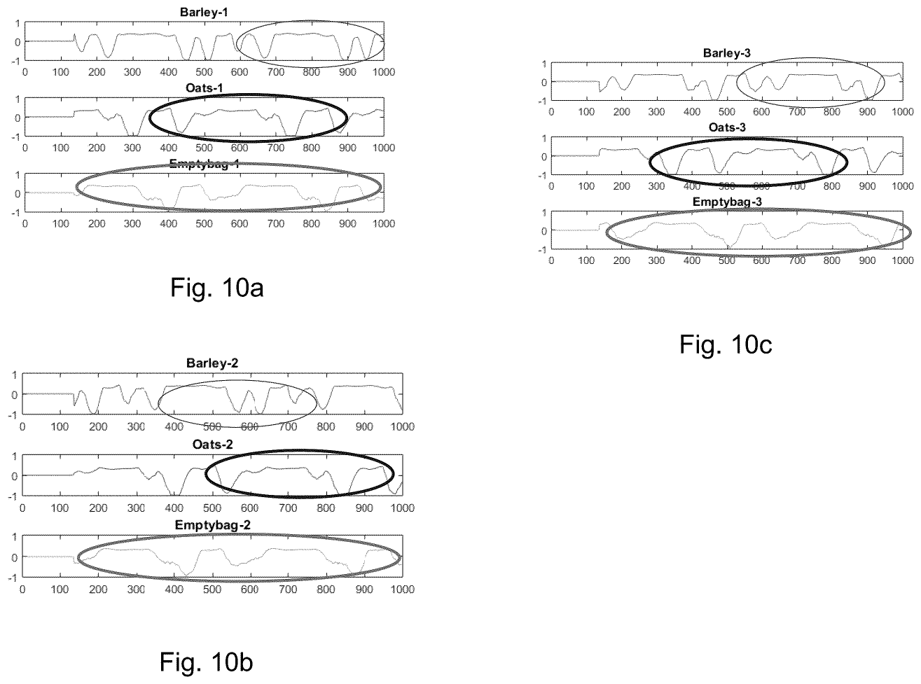

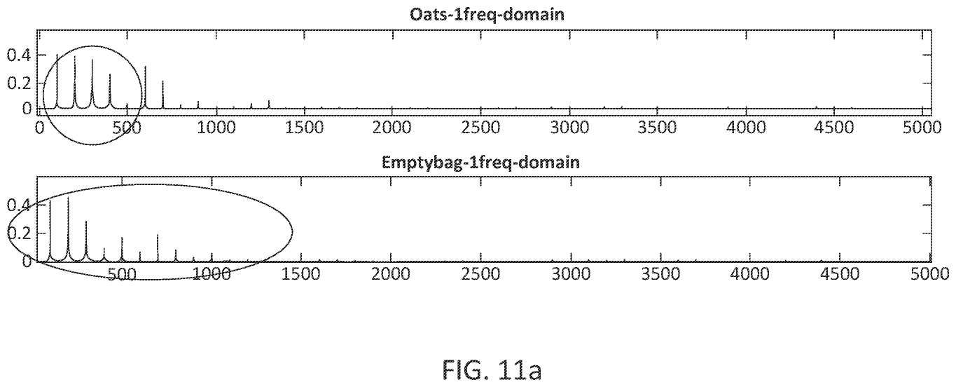

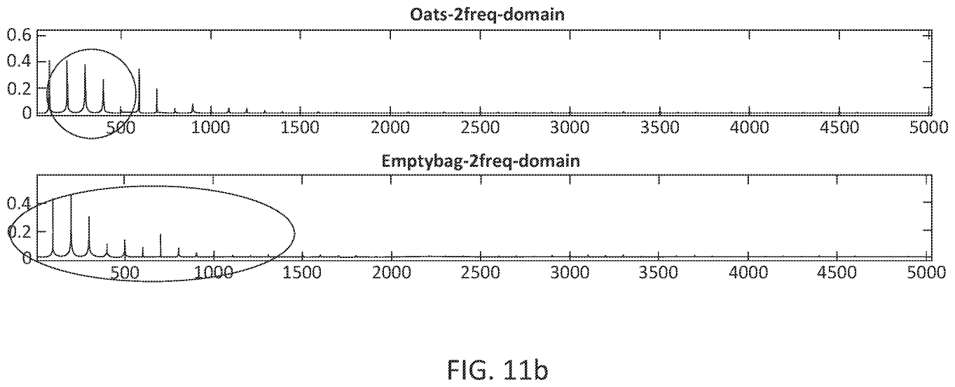

The designs may be verified by the vectors generated in the Matlab model designs individually. Simulink designs may be used for creating the analog-to-digital converter module and the fast Fourier transform module. A snapshot of the wireshark receiving Ethernet packet is set forth in FIG. 6. An example of the packet is set forth in FIG. 7. A snapshot of the Matlab Code is set forth below.

y=fft(sampled_and_quantized_sine,8); % sampled_and_quantized_sine:

ADC value str=dec2bin(sampled_and_quantized_sine,12)

where % converts dec to bin with 12-bit width.

The frequency and time domain graphs for various stationary objects, examples of which include guns and explosive materials are set forth in FIG. 13.

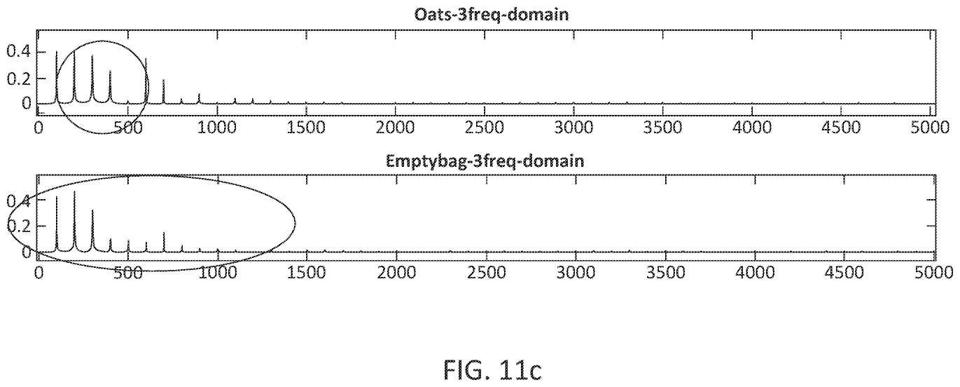

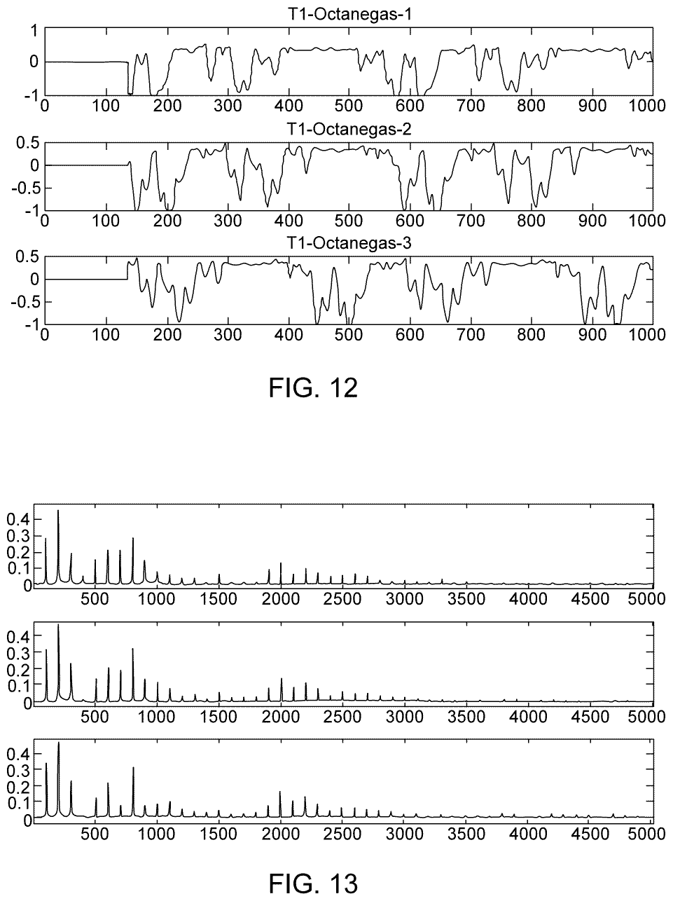

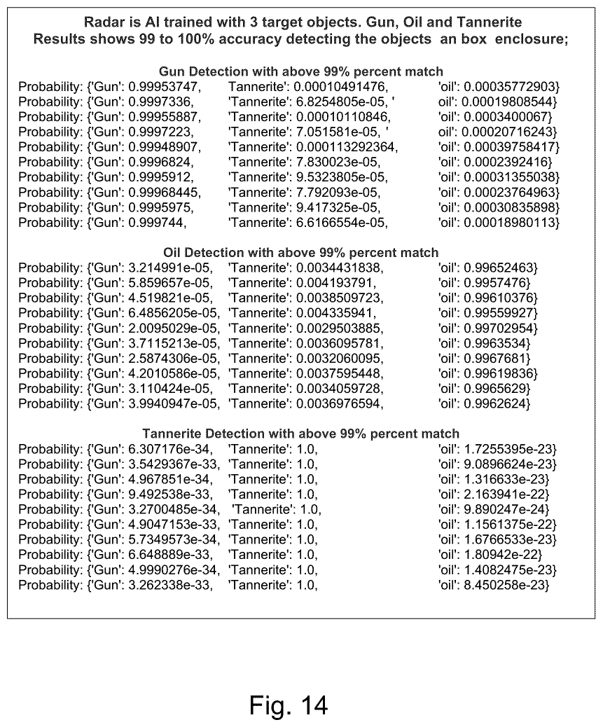

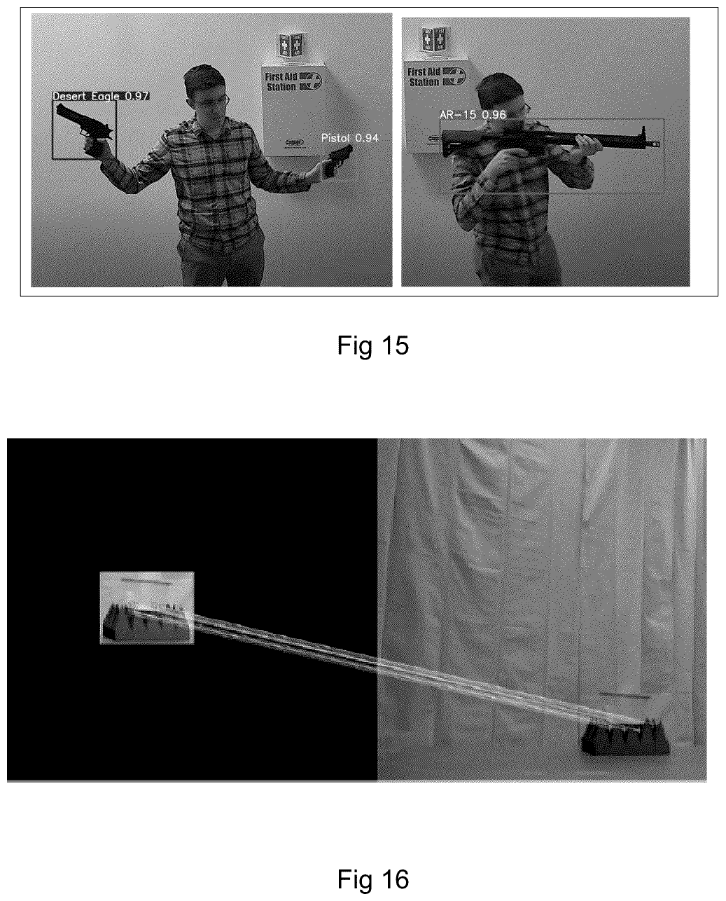

FIG. 12 provides sample test results of the threat detection system being developed for school safety. The threat detection system can also be used in conjunction with other types of buildings and/or locations.

For example, the threat detection system may be used at airports to evaluate each of the persons and objects. Because of the nature of the invention, the persons do not need to remove objects from their bodies so that the objects can be scanned separately from the scanning of their bodies.

The threat detection system greatly decreases the time for authorities to scan for threats using current technology. The threat detection system thereby enhances the experience of the persons at the airport because the persons are subject to less inconvenience, but at the same time providing an enhanced level of security to ensure that the persons, the airport and the airplanes are safe.

These concepts can also be adapted for other structures such as government buildings, theatres, and sports stadiums. The advantages are more significant for scanning persons and objects that are not in an enclosed region such as a building. For example, persons who are gathering for a large outdoor event can be evaluated for threats without the need for erecting barriers that require individual persons to be individually scanned for threats prior to accessing the outdoor event. For example, presidential inaugurations have drawn more than one million people to the National Mall in Washington, D.C. The nature of these types of events make them targets for terrorism and the size of these events make it impractical to individually scan each of the attendees for potential threats using currently available technology.

As an example of detection of drugs, agriculture, soil or other item or ingredients type nature provided is a quick 10 second sample testing that shows the distinct signature between barley (gluten) and oats seeds.

As an example of detection flammables/combustible, FIG. 12 includes 10 second scan of gasoline. For example, of chemical (as can be use in an explosion), FIG. 12 includes a 10 second scan signature of Methanol.

Conventional weapons such as guns, rifles, knives of various metals can be detected in numerous ways. The invention can also do material signature, shape, and key features (trigger, etc. and metallic color code. When the system is trained by scanning a particular object, the accuracy greatly increases. For example, the training can increase accuracy to about one million points as compared to about 8,000 points when the system is not trained on the particular object. The invention can also be used in conjunction with evaluating metal, construction, bridge, and other materials fatigue due to oxidation, wear and tear and deterioration detection.

Examples of solutions in which the threat detection system may be implemented include border protection, communications, financial services, critical manufacturing, mass events, water and waste treatment systems, commercial facilities, information technology, transport systems, defense industrial base, law enforcement, defense, health and public healthcare, nuclear reactors, materials and waste, food, and agriculture, chemical and pharmaceuticals, emergency services and government facilities.

The computer vision toolbox is used efficiently to represent the interesting parts of the detected object through radar. This method is used because it is quick in completing the comparison algorithms such as image matching and retrieval. An algorithm is used for detecting a specific object based on finding a point matching between the reference and the target image. The invention may utilize deep learning techniques that automatically learn useful feature representation directly from the image data/heat maps.

Data collection is one of the crucial parts in developing radars at theater mission planning system (“TMPS”). A large amount of data must be collected to improve the quality of the radar systems, especially when it comes to developing artificial intelligence and machine learning algorithms. Databases and file storage servers are used to store, manage, and analyze data.

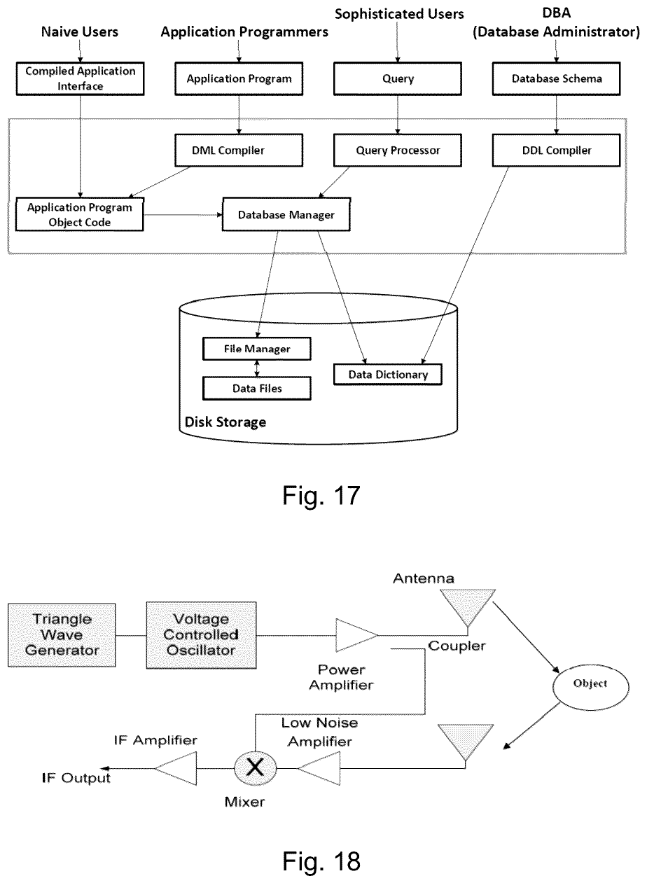

As shown in FIG. 17, block diagram data definition language (“DDL”) scripts, DML scripts, SQL Queries, extract, transform, load (“ETL”) codes are written to create/drop objects and manipulate the data as needed on the database (disk storage). A database management system is responsible for accessing data, inserting, updating, and deleting data, security, integrity, facilitated by locking, logging, application-defined rules, including triggers, supporting batch and on-line programs, facilitating backups and recoveries, optimizing performance, maximizing availability, maintaining the catalog and directory of database objects, managing the buffer pools and acting as an interface to other systems programs.

Supporting user interface packages, such as the popular structured query language (“SQL”) interface for relational database systems. Using databases reduces data redundancy, reduces updating errors and increases consistency, greater data integrity and independence from applications programs, improved data security, reduces data entry, storage, and retrieval costs.

The signature values are stored and indexed on the database (generated by field-programmable gate array). In the process of detecting a material using the radar, the signature values generated by field-programmable gate array are matched with the database and the additional information related to the match is retrieved and is passed on to the next application like image generator. Databases are usually organized into one or more tables. Sound or image files are stored on file storage servers and the location of the files are stored and indexed on the database.

A combination of databases/big-data and machine learning algorithms is considered as the best approach in developing TMPS radars. Machine learning plays a major role in analyzing the incoming data and identifying the objects.

Complex algorithms are written to learn from data and make data-driven predictions and decisions. Algorithms are written to model complex relationships between input and outputs and to find patterns in data. During the machine learning process, the database that is built to store the radar scans of any given object is used as the data for the algorithm to learn, analyze and identify the patterns. The more data, the more accuracy in identifying an object. Computer code languages like Python, R, C++, Java, etc. are used in creating machine learning algorithms.

Steps involved in developing radar machine learning algorithms are data processing, regression, classification, clustering, artificial neural networks (deep learning), reinforcement learning, etc.

Data processing is part of machine learning where the data is formatted to make it consistent, reducing the amount of data that is provided for machine learning (using attribute sampling, record sampling, aggregating, etc.), cleaning up on missing values which can tangibly reduce prediction and detection accuracy, rescaling data, etc.

Classification is an algorithm to answer binary yes-or-no questions (like threat or no threat, good or bad, armed, or unarmed) or to make a multiclass classification (like grass, trees, or bushes; cats, dogs, or birds etc.). The data provided must be labeled so that the algorithm can learn from the data.

Clustering is an algorithm to find the rules of classification and the number of classes. Regression is an algorithm to yield some numeric value. For example, if too much time is spent coming up with the right price for a product, since it depends on many factors, regression algorithms can aid in estimating this value.

Artificial neural networks systems “learn” (i.e., progressively improve performance on) tasks by considering examples, generally without task-specific programming. For example, in image recognition, the systems might learn to identify images that contain cats by analyzing example images that have been manually labeled as “cat” or “no cat” and using the results to identify cats in other images. The systems do this without any a priori knowledge about cats, e.g., that they have fur, tails, whiskers and cat-like faces. Instead, the systems evolve their own set of relevant characteristics from the learning material that they process.

Reinforcement learning is concerned with how an agent ought to take actions in an environment so as to maximize some notion of long-term reward. Reinforcement learning algorithms attempt to find a policy that maps states of the world to the actions the agent ought to take in those states.

The invention is based on using unique millimeter wave frequency profiles of the various threat types (guns, explosives, chemicals, fertilizer, etc.) in the system stored database. The radar, signal processing, database management and communication operation has to be managed autonomously this required software/hardware special interface.

The millimeter frequency-modulated continuous-wave radar uses a combination of imaging and signal characteristic matching technology for target and threat detection. The first system, imaging, requires the beam of the radar be moved over a targeted area by sending command to the servo controller.

This controller receives these commands over the standard USB interface found on most consumer and commercial grade PC hardware. The serial commands are issued using custom software written in Object Pascal using Code Typhon IDE. This software is also responsible for retrieving and displaying the radar image. To achieve this, the custom radar software may act as a supervisor for the complete radar system.

First, the program sends a command to the commercial program spectrum laboratory to obtain a fast Fourier transformation array of 2048 floating point number data. The spectrum laboratory in turn will make a request to a standard sound card (or field-programmable gate array) to retrieve one million 16-bit analog-to-digital converter samples.

These samples are then converted to the fast Fourier transformation array that is sent to the radar supervisor program. Once these 2048 floating point numbers are in the memory buffer of the supervisor program, it scales and converts these to intensity values useful for displaying. After all values have been converted, they are displayed sequentially column after column from left to right until the screen is filled with a visible image.

This image is then compared to a known image of a target. The next step may use software from Matrox Imaging to pattern match the images to verify a match has been made. If no match is found, the process repeats. In the event a match is found, the software will issue a custom alert such as displaying a message on the screen, displayed with 3D software from Fastprotect or a message is sent to the user. An e-mail or text message may also be sent to dispatch. The notification can also be made by a telephone call.

The second matching technology uses the same custom radar superior program as the imaging system but matches the signal characteristic. The process is similar to the imaging system with the supervisor program starting the process. In this system a direct analog-to-digital converter is made from either the sound card or field-programmable gate array and one million 16-bit analog-to-digital converter samples are taken.

These values are then fed into a commercial program Matlab. Using custom scripts, this data is processed and checked for special signatures in the characteristic. These signatures are than matched to known signatures of a threat and if a match is found, a message is displayed on the screen of the user. An e-mail or text message may also be sent to dispatch.

The third matching technology uses a machine learning algorithm provided by a third party. This software analyzes the wave pattern of the radar return and breaks the complete scan into smaller signal clusters that are matched to several known radar return clusters and a statistical analysis is preformed to determine how close the known target clusters are to the unknown target cluster. A trigger threshold is set that when the probability of a good match is found a message is sent to notify the appropriate individual(s) to remove the threat.

The millimeter radar is a type of frequency modulated continuous wave design. The entire radio frequency front-end may be synchronized by a single local oscillator around 9 GHz. This frequency may be ramped up and down in a triangle waveform pattern at 100 Hz generated from a lab.

If the field-programmable gate array is used, a driver circuit may be used to convert the 0 to 3.3 v output to the required 0 to +15 v range of the voltage controlled coupled feedback oscillator. This 9 GHz signal is then multiplied and filtered to the required output frequency. This radio frequency signal is fed to an antenna. For shorter range, the antenna may be a horn antenna. For longer range sensing, the antenna may be a lens type antenna.

The signal leaves the radar, bounces from the target and returns at the speed of light. This signal is then mixed with the same local oscillator signal used to transmit the original signal. Since this signal has now slightly moved from the 100 Hz ramp, a small signal shift will occur. This difference indicates the distance from the sensor to the target. For example, if the target is near the sensor and the radar operates at 70 GHz to 75 GHz and the initial frequency was exactly at 70 GHz when it hits the target and returns to the radar which already has increased now to 70.1 GHz the output would be 0.10 GHz.

If the target were farther away, the delay returning to the radar would be longer and the shift would be wider to 0.20 GHz or greater depending on the range. This output difference signal or intermediate frequency signal is then amplified and sent to the analog-to-digital converter of either a standard PC sound card or analog-to-digital converter controlled and captures by field-programmable gate array for digital signal processing.

The entire radar front-end may be mounted on a motion-controlled chassis. This chassis may be manipulated by two high-precision servo motors that are driven by a pulse width modulation control board by Pollo-U Technologies. Serial commands are sent over the standard universal serial bus either from a standard PC or field-programmable gate array to set the position of the radar. The miniaturized nano version of the radar may use a multipurpose MINT chip.

This chip includes the voltage-controlled oscillator operating in the range from 23.3 GHz to 25.0 GHz that feeds a 3× multiplier creating the necessary 70 GHz to 75 GHz range that drives both the transmit and receive channels. The MINT chip also includes both the transmit and receive amplification and mixing stages to generate the intermediate frequencies resulting from the detected target(s).

The threat detection sensor uses frequency-modulated continuous-wave radar technology to sense and identify unknown objects. Commonly this type of radar is used to determine range and velocity of a target object. Our approach expands the signal processing to include more subtle characteristics of the return signal related to the shape of the object and its material composition.

The incorporated frequency-modulated continuous-wave radar continually transmits a microwave frequency that varies with time. Typically, the frequency variation is linear changing from F_{low} to F_{high} over a time period T and then reversing direction varying from F_{high} to F_{low} over the same length of time. The transmitted signal is reflected by a target and returns to the radar receiver after a time delay Td that is determined by the round-trip travel time of the microwave signal from the radar to the target and back.

Since the microwave signal travels at the speed of light the time delay is: Td=2R/c. Where R is the range to the target and c is the speed of light. The return signal is then mixed with the signal being transmitted at the time the signal returns producing an IF or beat frequency signal at a frequency:

F_{if}=(F_{high}−F_{low})*(Td/T)

Using the relationship between Td and R we can show:

R=(F_{if}/(F_{high}−F_{low}))*(Tc/2)

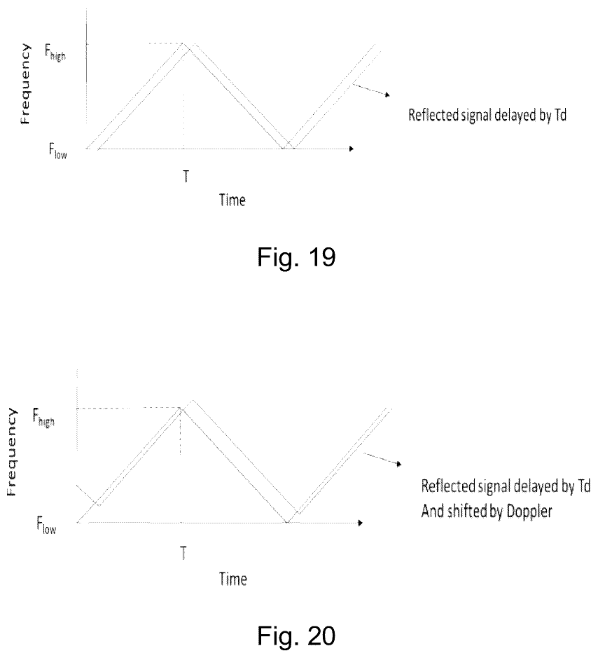

So there is a direct relationship between IF frequency and range to the target. As an aid in visualizing the frequency-modulated continuous-wave radar process a block diagram of a typical radar system and plots of frequency versus time are shown in FIGS. 19 and 20.

FIG. 19 illustrates a frequency-modulated continuous-wave radar system detecting reflected signal from object. FIG. 20 illustrates frequency-modulated continuous-wave radar transmitted and reflected frequency versus time.

In the case of a moving target the frequency of a return signal is shifted by Doppler shift as well as the range delay. If the target is moving towards the radar transceiver the frequency is increased by the Doppler shift. If it is moving away, the frequency is decreased. The Frequency of the Doppler shift is:

F_{d}=F_{rf}*V/c

Where F_{rf} is the frequency of the radio frequency signal and V is the velocity of the target.

During the period when the frequency is increasing from F_{low} to F_{high}, the Doppler frequency shift lowers the intermediate frequency so:

F_{if}=(F_{high}−F_{low})*(Td/T)−F_{d}

During the period when the frequency is decreasing from F_{high} to F_{low}, the Doppler frequency increases the intermedia frequency so:

F_{if}=(F_{high}−F_{low})*(Td/T)+F_{d}

By looking at the intermediate frequency difference between the upsweep and down sweep the range and velocity can be solved for separately. In addition to these basic measurements, the approach will use signal processing algorithms that look more closely at the time and frequency domain characteristics of the return signals to identify potential threat objects. One example of more advanced signal processing is the use of synthetic aperture radar frequency-modulated continuous-wave. The approach is based on a new approach matching signal returns to templates stored in a database.

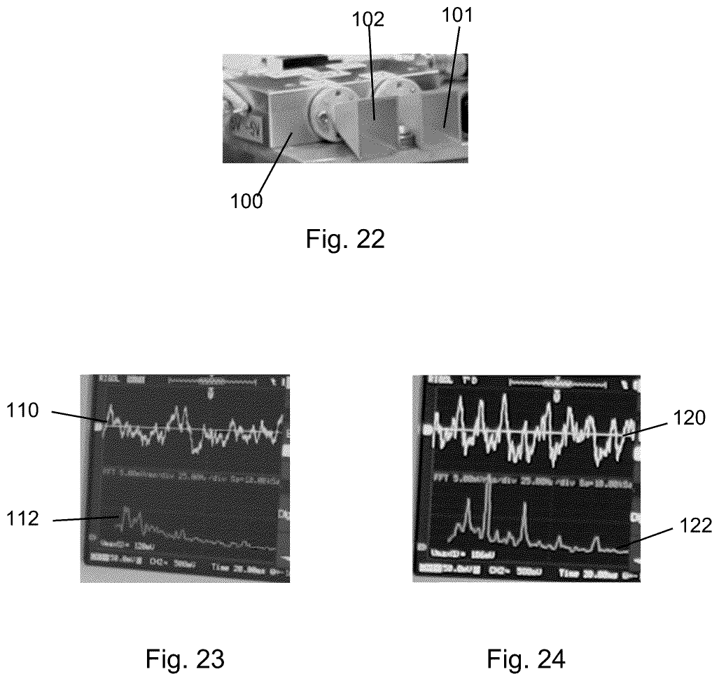

FIG. 22 is a perspective view of an FMCW radar detector 100 for detecting drones. The FMCW includes at least one transmitter 101 and one receiver 102. In certain embodiments, the FMCW radar detector 100 includes multiple receivers 102. While it is illustrated that the transmitter 101 and receivers 102 are both oriented in the same direction, this allows the allows the transmitter signal to reflect off the drone and captured by the receiver 102.

FIG. 23 illustrates a baseline ambient profile that is received by the FMCW radar detector 100 when the drone's propeller is not spinning in proximity thereto. The upper profile 110 represents the time domain ambient profile. The lower profile 112 represents the frequency domain ambient profile.

When a drone propeller is operated in proximity to the FMCW radar detector 100, the MMW/RF signal is reflected by the drone and the spinning propeller of the drone. FIG. 24 illustrates the profile that is received by the FMCW radar detector 100 when the drone's spinning propellers reflect the transmitted signal into the FMCW radar detector 100. The upper profile 120 represents the time domain Drone with spinning propeller profile. The lower profile 122 represents the frequency domain Drone with spinning propeller profile.

The difference between the propeller spin profiles illustrated in FIG. 23 and FIG. 24 is used to compare to the various drone propellers profile signature. The machine learned/artificial intelligence signature match is then utilized to identify the drone type and optimally other detected features such as the drone the size and configuration help confirm the drone model.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in several different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A method of detecting threats comprising:
providing a threat detection system comprising a controller, a millimeter wave radar, a signature database and a camera, wherein the signature database comprises a time and frequency domain characteristic data for a threat;
emitting a signal by the millimeter wave radar;
receiving a return signal when the signal bounces off an object; and
comparing time and frequency domain characteristic data of the return signal to the signature database.

2. The method of claim 1, wherein the millimeter wave radar comprises a frequency-modulated continuous-wave radar.

3. The method of claim 1, and further comprising reviewing the threat to confirm a classification.

4. The method of claim 1, and further comprising notifying at least one of public safety and security when the threat is detected.

5. The method of claim 4, wherein the notifying is done using at least one of an electronic transmission, a display, an email, a text message and a telephone call.

6. The method of claim 4, and further comprising transmitting at least one of an identification of the threat, an image of the threat and a location of the threat.

7. The method of claim 1, and further comprising changing a direction in which the signal is emitted by the millimeter wave radar to scan an area for threats.

8. The method of claim 1, wherein the threat detection system scans at frequencies of between about 10 GHz and about 330 GHz.

9. The method of claim 1, wherein the threat detection system processes data associated with the return signals at greater than about 10 Gbps.

10. The method of claim 1, wherein the threat detection system conducts up to about one million scans per second.

11. The method of claim 1, and further comprising obtaining an image of the threat with the camera that is associated with the threat detection system.

12. The method of claim 11, and further comprising directing the camera at the threat to obtain the image of the threat.

13. The method of claim 11, and further comprising analyzing the image to identify the threat.

14. The method of claim 1, wherein the threat comprises at least one of flammables, combustibles, chemicals, drugs, agriculture products, soil and weapons.

15. The method of claim 1, and further comprising utilizing artificial intelligence to review the return signal.

16. The method of claim 1, wherein the threat detection is done in autonomously in real-time.

17. The method of claim 1, and further comprising training the threat detection system prior to using the threat detection system to identify the threat.

18. The method of claim 1, and further comprising automatically engaging an access control device to prevent a person from entering a structure associated with the access control device when the person possesses the threat.

19. The method of claim 1, evaluating at least one of a person and an object that is not in a confined region in a non-individualized manner to determine whether the person and the object possess the threat.

20. A threat detection system comprising:
a controller;
a millimeter wave radar that is capable of emitting a signal and receiving a return signal that bounces off an object;
a signature database that contains time and frequency domain characteristic data for at least one threat, wherein the controller compares the return signal to the time and frequency characteristic data to identify a threat; and
a camera that is directed to the threat and captures an image of the threat.

21. A threat detection system comprising
a controller;
a millimeter wave radar that is capable of emitting a signal and receiving a return signal that bounces off an object;
a signature database that comprises time and frequency domain characteristic data for at least one threat, wherein the controller compares the return signal to the time and frequency characteristic data to identify a threat; and
an access control device that is associated with a structure, wherein the access control device engages after the threat is detected.
